(19) United States
(12) Patent Application Publication
(10) Pub. No.: US 2016/0150590 A1
(43) Pub. Date: May 26, 2016

(54) METHOD AND SYSTEM FOR INDICATING A MULTICAST SESSION TO USER EQUIPMENT (UE) IN AN IDLE MODE

(71) Applicant: Samsung Electronics Co., Ltd., Gyeonggi-do (KR)

(72) Inventors: Thejeswara Reddy POCHA, Bangalore (IN); Yuvaraj THIAGARAJAN, Bangalore (IN)

(73) Assignee: Samsung Electronics Co., Ltd.

(21) Appl. No.: 14/712,448

(22) Filed: May 14, 2015

(30) Foreign Application Priority Data
Nov. 21, 2014 (IN) 5852/CHE/2014

(51) Int. Cl. H04W 76/04; H04W 68/02; H04L 29/06

(52) U.S. Cl. CPC H04W 76/046; H04L 65/4076; H04L 65/1066; H04W 68/02; H04W 88/08

(57) ABSTRACT

A system that uses a method for indicating a multicast session to a user equipment (UE) in an idle mode by a base station is provided. The method includes detecting availability of an enhanced multimedia broadcast multicast service (eMBMS) session and indicating the eMBMS session to the UE in a paging message.

### PRIORITY

This application claims priority under 35 U.S.C. §119(a) to Indian Patent Application Serial No. 5852/CHE/2014, which was filed in the Indian Intellectual Property Office on Nov. 21, 2014, the entire disclosure of which is incorporated herein by reference.

### BACKGROUND

1. Field of the Disclosure

The present disclosure relates generally to an evolved multimedia broadcast multicast service (eMBMS) for a mobile communication system, and more particularly, to indicating an eMBMS session to a user equipment (UE) in an idle mode.

2. Description of the Related Art

To enhance multimedia performance of a Third Generation (3G) mobile telecommunications system, the 3rd Generation Partnership Project (3GPP) introduces an MBMS, which is a point-to-multipoint bearer service established on an existing network architecture of the universal mobile telecommunications system (UMTS). MBMS allows a source terminal to simultaneously transmit data to multiple UEs through internet protocol (IP) packets.

However, as the multimedia performance of UEs advances, consumers are more interested in having multimedia or mobile TV services through their UEs. In order to meet such requirement, the 3GPP introduces an eMBMS in a specification of long term evolution (LTE) Release-9, to support high quality streaming multimedia and real-time MBMS services.

The eMBMS uses a single frequency network (SFN) operation for MBMS transmission, i.e. an MBMS single frequency network (MBSFN), to reduce service interruption caused by frequency switching during signal transmissions. In MBSFN, single frequency is used by multiple cells to perform synchronized transmission at the same time, so as to save frequency resources and enhance spectrum utilization. An area covered by an MBSFN is called an MBSFN area. Two logical channels are defined in eMBMS to support point-to-multipoint downlink transmission: multicast control channel (MCCH) and multicast traffic channel (MTCH). MCCH are utilized for transmitting control messages of all MBMS services in an MBSFN area, and MTCH is utilized for transmitting session data of an MBMS service. The session data relates to contents of the MBMS service. Both MCCH and MTCH are mapped to a transmission channel newly defined by eMBMS, i.e. MCH. However, if the UE is in idle mode, the current eMBMS standardization does not provide a mechanism to the UE to dynamically determine availability of eMBMS sessions.

In some cases, like public safety, using the eMBMS or broadcast multicast service center (BMSC), a group communication system enabler (GCSE) application server (GCSE AS) may be configured to switch to the eMBMS from unicast services to a group of users based on the number of simultaneous users accessing the group services. If the UE is in idle mode, the eMBMS changes in the cell will not be sent to UE.

### SUMMARY

The present disclosure has been made to address at least the above mentioned problems and/or disadvantages and to provide at least the advantages described below.

An aspect of the present disclosure is to provide a method and system for indicating a multicast session to UE in an idle mode.

Another aspect of the present disclosure is to provide a method for joining a multicast session by UE in the idle mode. Accordingly the invention provides a method for indicating a multicast session to user equipment (UE) in an idle mode by a base station. The method includes detecting availability of an enhanced multimedia broadcast multicast service (eMBMS) session. Further the method includes indicating the eMBMS session to the UE in a paging message.

Accordingly the invention provides a system a system for initiating a multicast session. The system comprises a base station and user equipment (UE). The base station is configured to detect availability of an enhanced multimedia broadcast multicast service (eMBMS) session. The base station is configured to indicate the eMBMS session to a user equipment (UE) in a paging message. The UE is configured to receive a paging message from the base station supporting the eMBMS session. The paging message indicates a multicast control channel (MCCH) change notification. The UE is configured to switch to a connected mode from the idle mode to decode a MCCH channel based on the MCCH change notification. Further the UE is configured to obtain MBMS data by extracting a multicast traffic channel (MTCH) in the MCCH channel. Furthermore the UE is configured to join the eMBMS session based on the MBMS data.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram illustrating a wireless communication system for delivering MBMS data, according to an embodiment of the present disclosure;

FIG. 2A is a block diagram illustrating a base station with various modules, according to an embodiment of the present disclosure;

FIG. 2B is a block diagram illustrating a UE with various modules, according to an embodiment of the present disclosure;

FIG. 3 is a flowchart illustrating a method for indicating a multicast session to the UE in an idle mode by the base station, according to an embodiment if the present disclosure;

FIG. 4 is a flowchart illustrating a method for joining a multicast session by the UE in the idle mode, according to an embodiment of the present disclosure; and

FIG. 5 is a signalling diagram illustrating a procedure for indicating and initiating the multicast session, according to an embodiment of the present disclosure.

### DETAILED DESCRIPTION

Hereinafter, embodiments of the present disclosure are described in detail with reference to the accompanying drawings. Those of ordinary skill in the art will recognize that various changes and modifications of the embodiments described herein can be made without departing from the scope of the present disclosure. In addition, descriptions of well-known functions and constructions may be omitted for clarity and conciseness. The same reference symbols are used throughout the drawings to refer to the same or like parts.

It should be noted that various embodiments described below may be applied or used individually or in combination.

In accordance with embodiments of the present disclosure, a multicast session can be an ongoing session or new session.

A UE can be a cellular phone, a tablet, a laptop, and other multimedia device with wireless transceivers that communicate with the base station within a communication system. The base station, which are sometimes referred to as eNodeBs or eNBs, provide wireless services to the UE, within cells in the base station area.

Unlike conventional systems, the methods described herein provide information about the MBMS session to the UEs in idle mode. Whenever, there is a change in eMBMS data, a UE in idle mode is notified for a change in services. As can be appreciated, such methods can reduce a setup time required to initiate a eMBMS session.

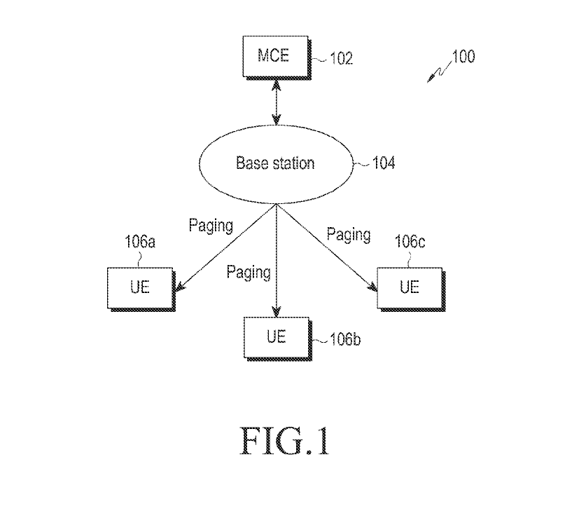

FIG. 1 is a diagram illustrating a wireless communication system 100 for delivering MBMS data, according to an embodiment of the present disclosure. A multi-cell/multicast coordination entity (MCE) 102 manages an eMBMS session by exchanging information and instructions with the base station (eNodeB) 104. The MCE 102 is a logical entity that is implemented over several devices or network elements within the wireless communication system 100. The MCE 102 determines whether to establish a bearer(s) of the new MBMS service(s) based on an allocation of resources corresponding to a MBMS service(s). Besides allocation of a time/frequency resources, the MCE 102 also determines details of the radio configuration. The MCE 102 is configured to count and acquire counting results for MBMS service(s). Resumption of MBMS session(s) within MBSFN area(s) are based on the counting results for the corresponding MBMS service(s), and suspension of MBMS session(s) within MBSFN area(s) are based on the counting results for the corresponding MBMS service(s).

The MCE 102 may be implemented within a single device or a network element. The MCE 102 performs functions such as admission control and allocation of radio resources for the MBSFN area. The base station 104 broadcasts a paging message to UEs 106a, 106b and 106c, which can operate in idle mode. As defined by a particular 3GPP specification of the system 100, the idle mode of the UEs 106a, 106b and 106c does not have a radio resource control RRC connection. Accordingly, in idle mode, the UEs 106a, 106b and 106c lack an RRC connection with the base station 104.

The paging message indicates an MCCH change notification. The MCCH change notification carries the MBMS service's configuration information.

The base station 104 includes a temporary multicast group identity (TMGI) of MBMS service for which it is broadcasted in the paging message.

Only an interested of the UEs 106a, 106b and 106c that is in idle mode decodes a MCCH channel based on the MCCH change notification. Further, the UEs 106a, 106b and 106c are configured to listen to an MTCH channel for receiving MBMS data. The proposed system 100 allows a UE in idle mode to determine an ongoing or new multicast session.

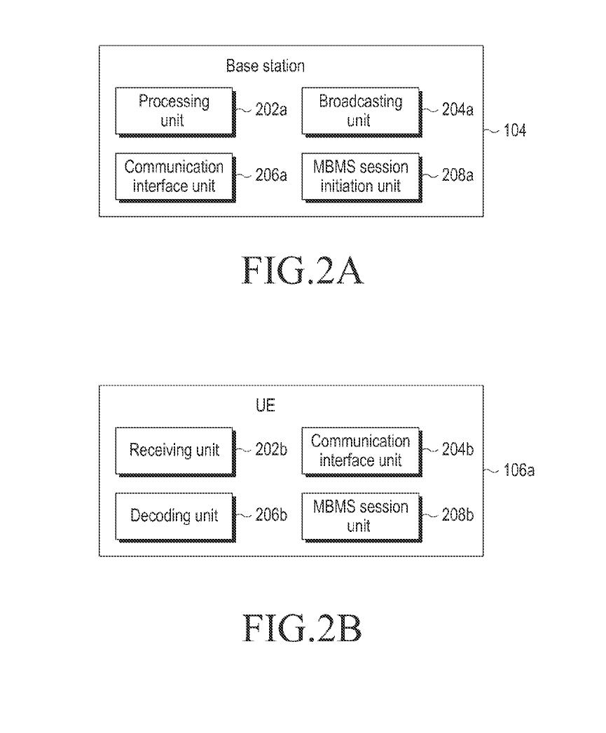

2A is a block diagram illustrating the base station 104 with various modules, according to an embodiment of the present disclosure. As shown in FIG. 2A, the base station 104 includes a processing unit 202a, a broadcasting unit 204a, a communication interface unit 206a and an MBMS session initiation unit 208a. The processing unit 202a is configured to detect an availability of an eMBMS session. The broadcasting unit 204a is configured to send a paging message to all of the UEs in the SFN area. The paging message indicates an MCCH change notification. The broadcasting unit 204a sends the paging message via a paging channel (PCH).

The broadcasting unit 204a includes a TMGI indicator in the paging message.

The communication interface unit 206a is configured to maintain communication between the UEs in the area covered by the base station 104. The broadcasting unit 204a sends the paging message through the communication interface unit 206a.

The MBMS session initiation unit 208a is configured to initiate an MBMS session once an interested UE(s) moves to a connected mode to establish a connection with the base station 104. The MBMS session initiation unit 208a allows the base station 104 to join an IP multicast group to receive the MBMS user plane data. The MBMS session initiation unit 208a allows the base station 104 to send the MBMS data to radio interface at a determined or predetermined time. The user plane data may be user traffic data. The user plane data may include content data such as a video, an image, and a file, etc. The user plane data may be included in the internet protocol (IP) layer.

FIG. 2B is a block diagram illustrating a UE with various modules, according to an embodiment of the present disclosure. For illustrative purposes, since the UEs 106a-106c, are identical, a description of the components that may be associated with the UE is described in terms of the UE 106a. As shown in FIG. 2B, the UE 106a includes a receiving unit 202b, a communication interface unit 204b, a decoding unit 206b and a MBMS session unit 208b. The receiving unit 202b is configured to receive a paging message from the base station 104. The communication interface unit 204b allows the UE 106a to maintain communication with the base station 104. After receiving the paging message, the communication interface unit 204b allows the UE 106a to move to a connected mode. The decoding unit 206b is configured to decode a MCCH channel based on the MCCH change notification indicated in the paging message. Further, the decoding unit 206b is configured to obtain MBMS data by extracting the MTCH in the MCCH channel.

The MBMS session unit 208b is configured to join an eMBMS session based on an MBMS data transmission.

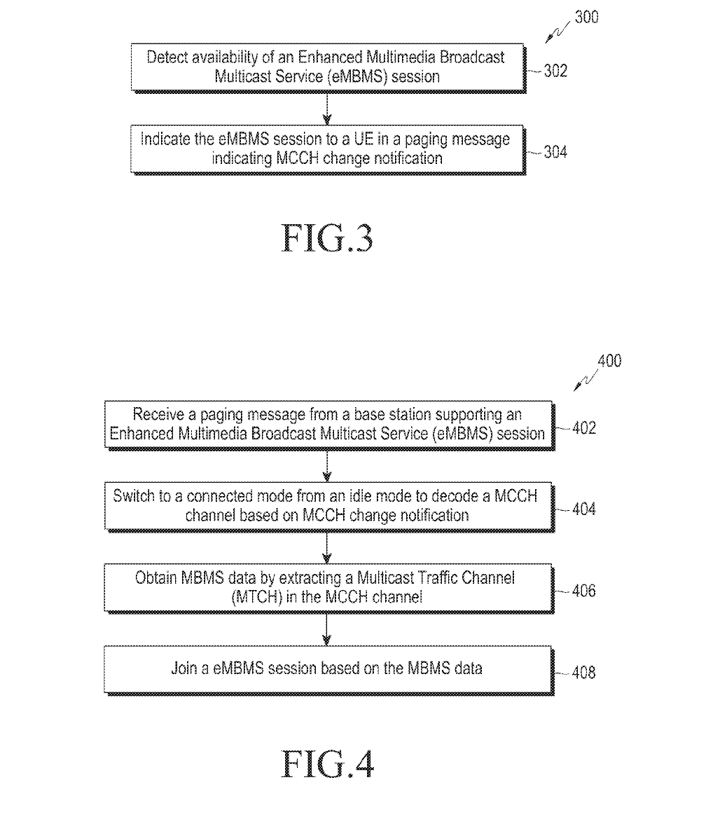

FIG. 3 is a flowchart of a method 300 for indicating the multicast session to a UE, e.g., the UE 106a, in the idle mode by the base station 104, according to an embodiment of the present disclosure. At step 302, availability of the eMBMS session is detected, by the processing unit 202a of the base station 104. The availability of the eMBMS session is detected when the MCE 102 sends the MBMS session start request.

At step 304, the eMBMS session is indicated to the UE in the paging message, thereby indicating an MCCH change notification. The broadcasting unit 204a sends the paging message through the communication interface unit 206a of the base station 104 to all the UEs in the serving area of the base station 104. Changes in the network are indicated to idle mode UE's using the paging message by the broadcasting unit 204a. The paging message is sent using the PCH and includes TMGI indicator.

In the instance where, the UE needs additional information to know a presence of an MCCH and configurations required to acquire the same, the base station 104 provides this information to the UE in a separate system information block (SIB) dedicated for MBMS-SIB-13.

FIG. 4 is a flowchart illustrating a method 400 for joining a multicast session by a UE, e.g., the UE 106a, in the idle mode, according to an embodiment of the present disclosure. At step 402, the paging message from the base station 104 supporting the eMBMS session is received by the receiving unit 202b of the UE 106a. At step 404, the connected mode is switched from the idle mode to decode the MCCH channel based on the MCCH change notification indicated in the paging message. The decoding unit 206b of the UE 106a decodes the MCCH channel based on the MCCH change notification. Further, the decoding unit 206b is configured to obtain MBMS data by extracting the MTCH in the MCCH channel. At step 408, the eMBMS session is joined to the UE 106a, based on the MBMS data, using the MBMS session unit 208b.

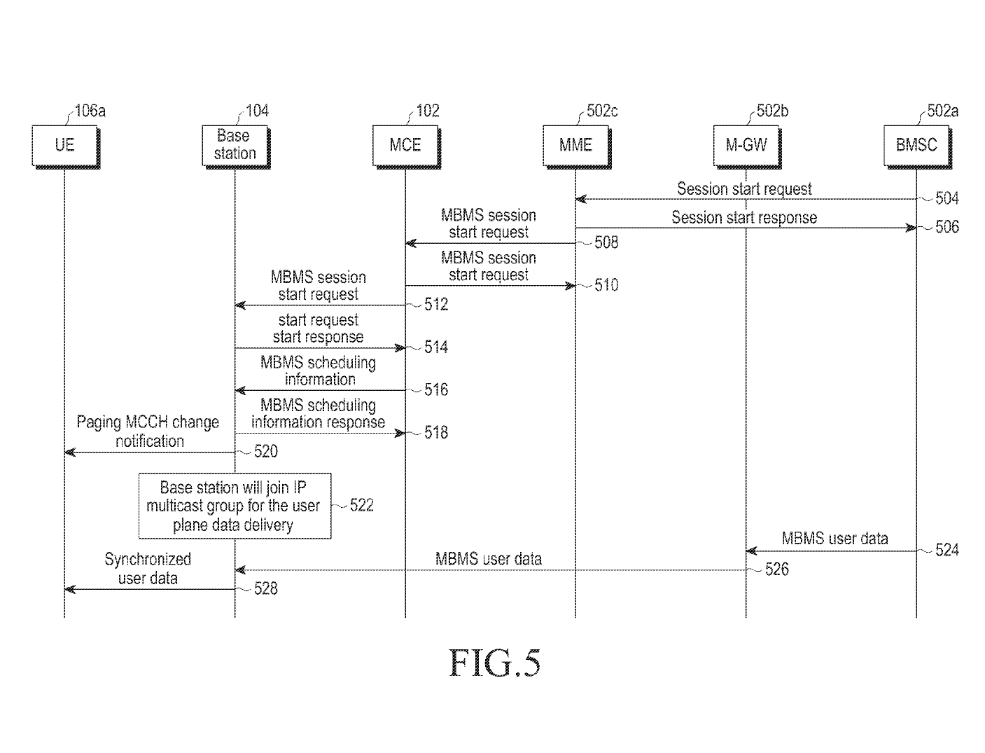

FIG. 5 is a signalling diagram illustrating a procedure indicating and initiating the multicast session, according to an embodiment of the present disclosure. Initially, a BMSC 502a sends, at step 504, a session start request to a mobility management entity (MME) 502c relating to a broadcast session start time. The MME 502c sends, at step 506, the session start response to the BMSC 502a.

The MME 504 sends, step 508, MBMS session start request message to the MCE 102 controlling eNB in the targeted MBMS service area. The message includes, for example, the IP multicast address, session attributes and a minimum time to wait before the first data delivery.

The MCE 102 checks whether the radio resources are sufficient for the establishment of new MBMS service(s) in the area it controls. If not, MCE 102 decides not to establish the radio bearers of the MBMS service(s) and does not forward the MBMS session start request message to the involved eNBs, or may pre-empt radio resources from other radio bearer(s) of ongoing MBMS service(s) according to allocation and retention priority (ARP). The MCE 102 confirms, at step 510, reception of the MBMS Session Start request to the MME 502c. The ARP may be one of Quality of Service (QOS) parameters at an eNodeB. Whether a bearer establishment or a modification request is accepted or needs to be rejected in case of resource limitation may be determined according to the ARP. In addition, the eNodeB may decide which bearer(s) to drop during exceptional resource limitations (e.g. at handover) according to the ARP.

Further, the MCE 102 sends, at step 512, the MBMS Session Start Request message to the base station 104 in the targeted MBMS service area. The MCE 102 then determines in which MBSFN area(s) the service should be delivered. Base station 104 confirms, at step 514, the reception of the MBMS Session Start message.

MCE 102 sends, at step 516, the MBMS Scheduling Information message to the base station 104 including the updated MCCH information which carries the MBMS service's configuration information. Base station 104 confirms, at step, 518, reception of the MBMS Scheduling Information message.

Base station 104 indicates, at step 520, a MBMS session start to UE 106a by including an MCCH change notification in a paging message and updated MCCH information, which carries the MBMS service's configuration information.

The paging message is sent via a PCH.

The base station 104 includes a TMGI of MBMS service for which it is broadcasted in paging message.

The paging message indicating the MCCH change notification can be sent in a new information element, as illustrated in Table (I) below.

TABLE (1)

| | | |
|---|---|---|
| Paging -v123 0-IEs :: = | SEQUENCE { | |
| MCCH -Modification -r12 | ENUMERATED | OPTIONAL- NEED ON |
| | {true} | |
| nonCriticalExtension | SEQUENCE { } | OPTIONAL- NEED OP |

The base station 104 joins, at step 522, the IP multicast group to receive the MBMS user plane data. The BMSC 502a sends, at step 524, user plane data to the M-GW 502b. Then the M-GW 502b sends, at step 526, the user plane data to base station 104. Base station 104 sends the MBMS data to radio interface at the determined or predetermined time. Further, the base station 104 sends, at step 528, the synchronized user data to the UE 106a.

The embodiments disclosed herein can be implemented through at least one software program running on at least one hardware device and performing network management functions to control the elements. The elements shown in FIGS. 1, 2A 2B, and 5 include blocks which can be at least one of a hardware device, or a combination of hardware device and software module.

The embodiments disclosed herein can be implemented through a System on Chip (SoC) platform. For example, the components illustrated in FIGS. 2A and 2B, which are associated with the based station 104 and UEs 106a-106c, respectively, can be integrated on one or more substrates of an SoC. Alternatively, the components of the base station 104 and the UEs 106a-106c can be integrated on their own respective Soc.

While the present disclosure has been shown and described with reference to certain embodiments thereof, it should be understood by those skilled in the art that many variations and modifications of the method and apparatus described herein will still fall within the spirit and scope of the present disclosure as defined in the appended claims and their equivalents.

What is claimed is:

1. A method for indicating a multicast session to a user equipment (UE) in an idle mode by a base station, the method comprising:
detecting availability of an enhanced multimedia broadcast multicast service (eMBMS) session; and
indicating the eMBMS session to the UE in a paging message.

2. The method of claim 1, wherein the paging message indicates a multicast control channel (MCCH) change notification.

3. The method of claim 1, wherein the paging message is transmitted using a paging channel (PCH).

4. The method of claim 1, wherein the paging message includes a temporary multicast group identity (TMGI) indicator.

5. A method for joining a multicast session by a user equipment (UE) in an idle mode, the method comprising:
receiving a paging message from a base station supporting an enhanced multimedia broadcast multicast service (eMBMS) session, wherein the paging message indicates a multicast control channel (MCCH) change notification;
switching to a connected mode from the idle mode to decode an MCCH channel based on the MCCH change notification;
obtaining MBMS data by extracting a multicast traffic channel (MTCH) in the MCCH channel; and
joining the eMBMS session based on the MBMS data.

6. The method of claim 5, wherein the paging message is received when the UE is in a multimedia broadcast multicast service single frequency network (MBSFN) area.

7. The method of claim 5, wherein the paging message includes a temporary multicast group identity (TMGI) indicator.

8. A system for initiating a multicast session, the system comprising:
a base station configured to detect availability of an enhanced multimedia broadcast multicast service (eMBMS) session and indicate the eMBMS session to a user equipment (UE) in a paging message,
wherein the UE is configured to receive a paging message from the base station supporting the eMBMS session, wherein the paging message indicates a multicast control channel (MCCH) change notification, switch to a connected mode from the idle mode to decode an MCCH channel based on the MCCH change notification, obtain MBMS data by extracting a multicast traffic channel (MTCH) in the MCCH channel, and join the eMBMS session based on the MBMS data.

9. The system of claim 8, wherein the paging message is sent using a paging channel (PCH).

10. The system of claim 8, wherein the paging message includes a temporary multicast group identity (TMGI) indicator.

11. A base station for indicating a multicast session to a user equipment (UE) in an idle mode, the base station comprising:
a processing unit configured to detect availability of an enhanced multimedia broadcast multicast service (eMBMS) session; and
a broadcasting unit configured to indicate the eMBMS session to a user equipment (UE) in a paging message.

12. The base station of claim 11, wherein the paging message indicates a multicast control channel (MCCH) change notification.

13. The base station of claim 11, wherein the paging message is transmitted using a paging channel (PCH).

14. The base station of claim 11, wherein the paging message includes a temporary multicast group identity (TMGI) indicator.

15. A user equipment (UE) for joining a multicast session in an idle mode, the UE comprising:
a receiving unit configured to receive a paging message from a base station supporting an enhanced multimedia broadcast multicast service (eMBMS) session, wherein the paging message indicates a multicast control channel (MCCH) change notification;
a communication interface unit configured to switch to a connected mode from the idle mode to decode a MCCH channel based on the MCCH change notification;
a decoding unit configured to obtain MBMS data by extracting a multicast traffic channel (MTCH) in the MCCH channel; and
a MBMS session unit configured to join the eMBMS session based on the MBMS data.

16. The UE of claim 15, wherein the paging message is received when the UE is in a multimedia broadcast multicast service single frequency network (MBSFN) area.

17. The UE of claim 15, wherein the paging message includes a temporary multicast group identity (TMGI) indicator.

18. A system on chip (SoC) for multimedia devices, the SoC comprising:
a receiving unit configured to receive a paging message from a base station supporting an enhanced multimedia broadcast multicast service (eMBMS) session, wherein the paging message indicates a multicast control channel (MCCH) change notification;
a communication interface unit configured to switch to a connected mode from the idle mode to decode a MCCH channel based on the MCCH change notification;
a decoding unit configured to obtain MBMS data by extracting a multicast traffic channel (MTCH) in the MCCH channel; and
a MBMS session unit configured to join the eMBMS session based on the MBMS data.

19. The SoC of claim 18, wherein the paging message is received when the UE is in a multimedia broadcast multicast service single frequency network (MBSFN) area.

20. The UE of claim 18, wherein the paging message includes a temporary multicast group identity (TMGI) indicator.
